(19) United States
(12) Patent Application Publication
(10) Pub. No.: US 2024/0340621 A1
(43) Pub. Date: Oct. 10, 2024

(54) METHOD AND SYSTEM FOR MANAGING PERSONAL IOT NETWORK SERVICES

(71) Applicant: Samsung Electronics Co., Ltd., Suwon-si (KR)

(72) Inventor: Arunprasath RAMAMOORTHY, Bangalore (IN)

(21) Appl. No.: 18/628,582

(22) Filed: Apr. 5, 2024

(30) Foreign Application Priority Data
Apr. 6, 2023 (IN) 202341026099
Mar. 20, 2024 (IN) 202341026099

(51) Int. Cl. H04W 4/50; G16Y 30/00

(52) U.S. Cl. CPC H04W 4/50; G16Y 30/00

(57) ABSTRACT

The disclosure relates to a 5G or 6G communication system for supporting a higher data transmission rate. The present disclosure describes a method and a system for managing Personal IoT Network (PIN) services. For registration of a PIN service, the method comprises receiving a PIN services registration request from a PIN Element (PINE) of the PIN to register one or more new services. Thereafter, the method comprises validating whether the one or more new services being offered by the PINE can be part of the PIN and transmitting a PIN services registration response to the PINE upon validating. For de-registration of the PIN service, the method comprises receiving a PIN services de-registration request from the PINE to de-register the one or more new services. Thereafter, the method comprises validating whether the PINE is allowed to de-register the one or more new services, and transmitting a PIN services de-registration response to the PINE upon validating.

### CROSS-REFERENCE TO RELATED APPLICATIONS

This application is based on and claims priority under 35 U.S.C. § 119 to Indian Provisional Patent Application No. 202341026099 filed on Apr. 6, 2023, and Indian Complete Application No. 202341026099 filed on Mar. 20, 2024, in the Indian Intellectual Property Office, the disclosure of which is incorporated by reference herein in its entirety.

### BACKGROUND

### 1. Field

The present disclosure relates to wireless communication. Particularly, but not exclusively, the present disclosure relates to a method and a system for managing personal IoT network (PIN) services.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Personal IoT networks (PINs) provide local connectivity between user equipments (UEs) and/or non-3GPP devices. A PIN comprises PIN elements (PINEs) that communicate using a PIN direct connection or direct network connection and are further managed locally using a PIN Element with management capability (PEMC). The PINEs are UEs and/or non-3GPP devices which form part of the PIN. The PEMCs have the capability to provide a means for an authorised administrator to configure and manage a PIN. Further, a PINE with gateway capability (PEGC) provides means to PINEs to register and access 5G network services. The PEGC can also help in communication between two PINEs that are not within the range to use direct communication. A proximity services (ProSe) is a device-to-device (D2D) technology that allows long-term evolution (LTE) devices to detect each other and to communicate directly. PIN identifiers are unique identifiers associated with a PIN.

The PIN provides many services which may be consumed by the PINEs. However, not all services are accessible or allowed to be accessed by PINEs during the lifetime of the PIN. For instance, if any PINE is upgraded with a new hardware which results in extra services the PINE offers then there is no way for the PINE to convey the extra services the PINE offers without leaving the PIN and rejoining again. Analogously, when any of the PINE is not offering the services the PINE was offering at the time of joining the PIN due to any hardware or software failure, the PINE needs to leave and rejoin the PIN. This approach is not a viable and an efficient solution. Further, currently there is no mechanism to register a service(s) or to de-register a service(s) of a PINE in a PIN.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

The present disclosure tries to address the aforementioned problem associated with a PIN.

In an embodiment, the present disclosure relates to a method for managing personal IoT network (PIN) services. The method comprising receiving, by a PIN Element with management capability (PEMC) of the PIN, a PIN services registration request from a PIN element (PINE) of the PIN to register one or more new services. Subsequently, the method comprises validating, by the PEMC, whether the one or more new services being offered by the PINE can be part of the PIN (or are part of the PIN). Lastly, the method comprises transmitting, by the PEMC, a PIN services registration response to the PINE upon validating.

In another embodiment, the present disclosure relates to a system for managing PIN services. The system comprising a PEMC, wherein the PEMC comprises a processor and a memory communicatively coupled to the processor. The PEMC is configured to receive a PIN services registration request from a PINE of the PIN to register one or more new services. Subsequently, the PEMC is configured to validate whether the one or more new services being offered by the PINE can be part of the PIN (or are part of the PIN). Lastly, the PEMC is configured to transmit a PIN services registration response to the PINE upon validating.

The foregoing summary is illustrative only and is not intended to be in any way limiting. In addition to the illustrative aspects, embodiments, and features described above, further aspects, embodiments, and features will become apparent by reference to the drawings and the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and methods in accordance with embodiments of the present subject matter are now described below, by way of example only, and with reference to the accompanying figures:

FIG. 1A illustrates an environment for managing a PIN for PIN services registration in accordance with some embodiments of the present disclosure;

FIG. 1B illustrates environments for managing a PIN for PIN services de-registration in accordance with some embodiments of the present disclosure;

FIG. 1C illustrates environments for managing a PIN for PIN services de-registration in accordance with some embodiments of the present disclosure;

FIG. 2 illustrates a PEMC of a system for managing PIN services in accordance with some embodiments of the present disclosure;

FIG. 3A illustrate a flowchart of a method for managing a PIN for PIN services registration in accordance with some embodiments of the present disclosure; and

FIG. 3B illustrate a flowchart of a method for managing a PIN for PIN services de-registration in accordance with some embodiments of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

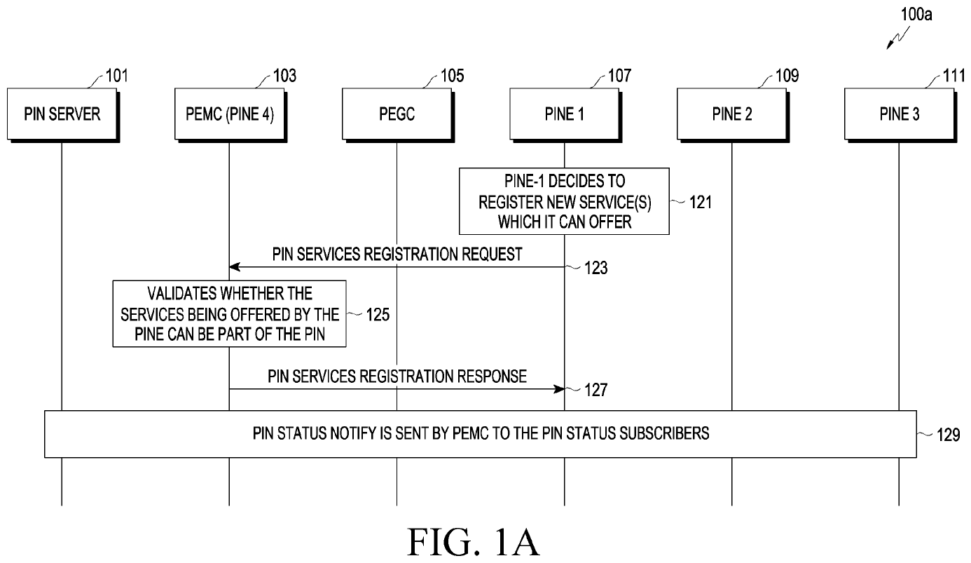

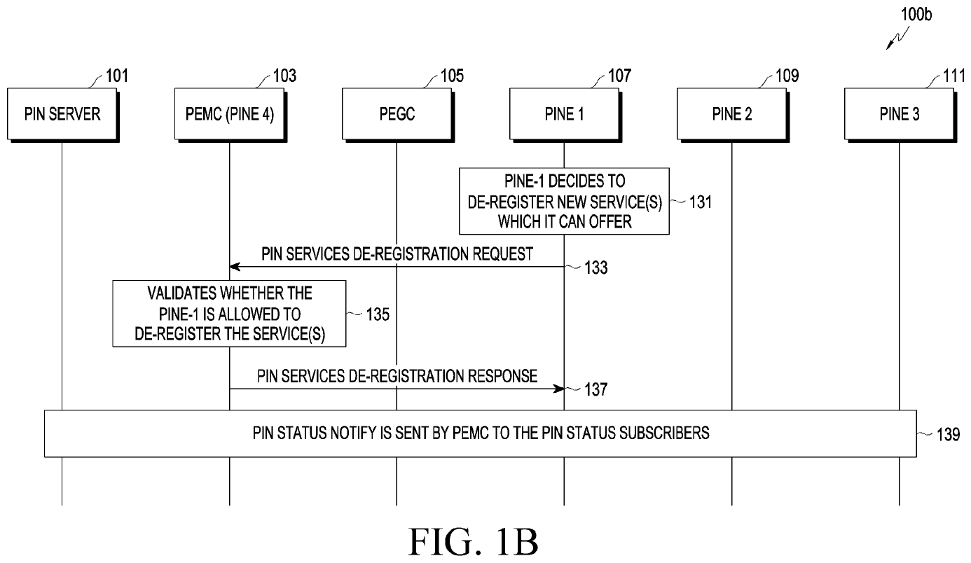

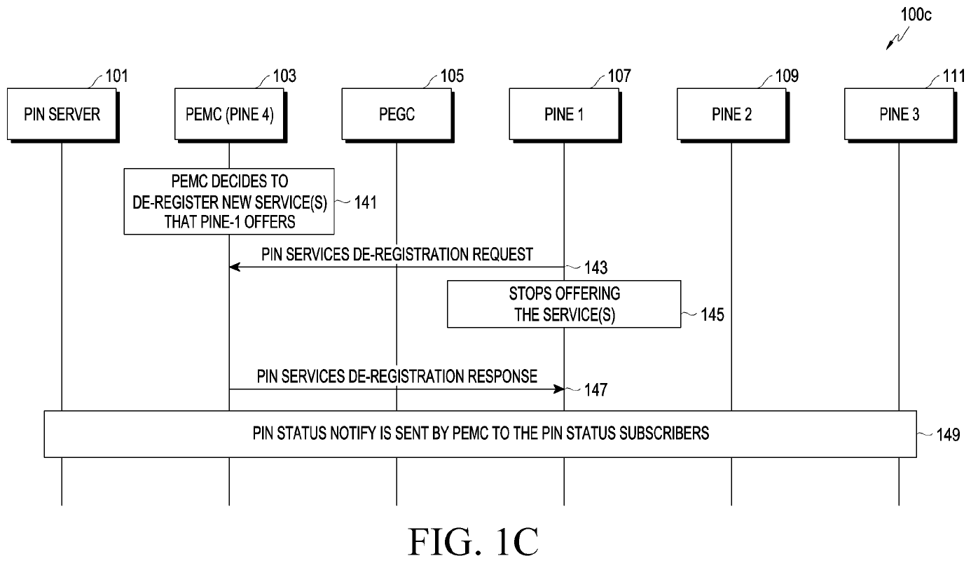

FIGS. 1A through 3B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises,” “comprising,” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure.

Services offered in the PIN may be the collection of services offered by the PINEs of a particular PIN. Each PINE when joining the PIN or when registering to the PIN may include the details (or information) of services each PINE offers. The details (or information) may include, but not limited to, a service type such as a printer, audio, video, and the like. A service identifier may be one of the details that comprises a unique identifier to identify the particular service. This can be generated by the PINE or it can be generated by PEMC and shared to the PIN element. Furthermore, additional service details such as human readable descriptions about the service may also be part of the details of the services. In an embodiment, the PINEs may need to update the services the PINEs offer after joining or registering to the PIN. The PINEs may not be able to offer the services due to hardware issue or any other issue or PINEs may be able to offer some more new services. In these cases, the PINE may be required to send the update request to the PEMC or the PIN server.

In an embodiment of the present disclosure, the procedures which may be considered as part of the PIN services management, include:

PINE is able to indicate or inform a PIN server or PEMC that the PINE is supporting/offering additional services than the PINE was offering at the time of registering or joining into the PIN.

PINE is able to indicate or inform the PIN server or PEMC that the PINE is no longer supporting/offering some services which the PINE was offering at the time of registering or joining into the PIN.

PEMC or PIN server is able to de-register or deactivate some or all of the services being offered in the PIN.

PIN owner or PIN administrator authorize or schedule the usage of the services offered in the PIN by the PINES.

PINE also associates the time period or time duration with each of the services the PINE is offering.

FIG. 1A illustrates an environment for managing a PIN for PIN services registration in accordance with some embodiments of the present disclosure.

With reference to FIG. 1A, the environment 100a comprises of a PIN server 101, a PEMC 103, a PEGC 105, and one or more PINEs i.e., a PINE-1 107, a PINE-2 109, and a PINE-3 111. The PIN server 101, the PEMC 103, the PEGC 105, and the one or more PINEs i.e., the PINE-1 107, the PINE-2 109, and the PINE-3 111 are all part of a same PIN. The PIN server 101, the PEMC 103, the PEGC 105, and the one or more PINEs i.e., the PINE-1 107, the PINE-2 109, and the PINE-3 111 may be referred as PIN entities. In one embodiment, the PIN server 101, the PEMC 103, the PEGC 105, and the one or more PINEs i.e., the PINE-1 107, the PINE-2 109, and the PINE-3 111 form a system. In another embodiment, only the PEMC 103 is part of the system.

The operation for managing the PIN for PIN services registration is explained with reference to FIG. 1A. The pre-conditions to perform this procedure or operation are (1) the PIN is already created or present and the PIN server 101, the PEMC 103, the PEGC 105, and the one or more PINEs i.e., the PINE-1 107, the PINE-2 109, and the PINE-3 111 are all part of the same PIN, and (2) the PINE-4 is currently the primary PEMC 103 of the PIN. As an example, it is considered that the PINE-1 107 is offering one or more new services which the PINE-1 107 was not offering at a time of joining the PIN.

Furthermore, the steps for performing this procedure are as follows:

PEMC (PINE-4), PEGC, PINE-1, PINE-2, PINE-3 all are joined as part of same PIN.

At step 121, the PINE-1 107 decides to register the one or more new services that the PINE-1 107 can offer (or the PINE-1 107 offers or the PINE-1 107 is capable of offering) which the PINE-1 107 was not offering at a time of joining the PIN. This may happen because of a UE on which the PINE (i.e., PINE-1 107) is existing has been upgraded to offer extra services or for any other reason which could be implementation specific or deployment specific.

At step 123, the PINE-1 107 transmits a PIN services registration request to the PEMC 103 when the PINE-1 107 decides to register the one or more new services. Analogously, the PEMC 103 receives the PIN services registration request from the PINE-1 107 of the PIN to register the one or more new services. The PIN services registration request comprises a PIN identifier, a PINE (i.e., PINE-1 107) identifier, and a first list of the one or more new services the PINE (i.e., PINE-1 107) is offering. The first list of the one or more new services comprises, but not limited to, a unique service identifier, a human readable description of a service, and time duration of when the service is available.

At step 125, upon receiving the PIN services registration request from the PINE-1 107, the PEMC 103 validates or checks whether the one or more new services being offered by the PINE-1 107 can be part of the PIN (or are part of the PIN). In detail, the PEMC 103 checks whether the one or more new services are allowed to be offered by the PIN by checking a PIN profile of the PIN. The PIN profile refers to configuration of the PIN and comprises information such as a type of services allowed, assignment of a role of PEMC, and PEGC, and a number of PINE allowed to be part of the PIN.

At step 127, upon validation, the PEMC 103 transmits a PIN services registration response to the PINE-1 107. Analogously, the PINE-1 107 receives the PIN services registration response from the PEMC 103. The PIN services registration response contains success or failure status of the PIN services registration request.

At step 129, upon successful validation at step 127, the PEMC 103 notifies at least one of details (or information) of the one or more new services and the details (or information) of the PINE-1 107 offering the one or more new services to all PIN entities in the PIN. At this stage, all PIN entities update their PIN dynamic information with the at least one of details of the one or more new services and the details of the PINE-1 107 offering the one or more new services. The PIN entities comprises at least one of the PIN server 101, the PEGC 105, the PINE-1 107, the PINE-2 109, and PINE-3 111. In case, the validation was unsuccessful at step 127, the step 129 is not performed or is omitted.

FIG. 1B illustrates an environment for managing a PIN for PIN services de-registration in accordance with some embodiments of the present disclosure.

With reference to FIG. 1B, the environment 100b comprises of the PIN server 101, the PEMC 103, the PEGC 105, and one or more PINEs i.e., the PINE-1 107, the PINE-2 109, and the PINE-3 111. The PIN server 101, the PEMC 103, the PEGC 105, and the one or more PINEs i.e., the PINE-1 107, the PINE-2 109, and the PINE-3 111 are all part of the same PIN. The PIN server 101, the PEMC 103, the PEGC 105, and the one or more PINEs i.e., the PINE-1 107, the PINE-2 109, and the PINE-3 111 may be referred as the PIN entities. In one embodiment, the PIN server 101, the PEMC 103, the PEGC 105, and the one or more PINEs i.e., the PINE-1 107, the PINE-2 109, and the PINE-3 111 form a system. In another embodiment, only the PEMC 103 is part of the system.

The operation for managing the PIN for PIN services de-registration is explained with reference to FIG. 1B. The pre-conditions to perform this procedure or operation are (1) the PIN is already created or present and the PIN server 101, the PEMC 103, the PEGC 105, and the one or more PINEs i.e., the PINE-1 107, the PINE-2 109, and the PINE-3 111 are all part of the same PIN and (2) the PINE-4 is currently the primary PEMC 103 of the PIN. As an example, the PINE-1 107 is currently offering one or more new services in the PIN. For the PIN services de-registration procedure, the term “one or more new services” may also be referred as “one or more services,” since the PIN services de-registration procedure is applicable to the one or more new services added during the PIN services registration (as explained with reference to FIG. 1A) and/or to the one or more services that existed with the PINEs while joining the PIN.

Furthermore, the steps for performing this procedure are as follows.

PEMC (PINE-4), PEGC, PINE-1, PINE-2, PINE-3 all are joined as part of same PIN.

At step 131, the PINE-1 107 decides to de-register the one or more new services that the PINE-1 107 currently offers. This may happen because the UE on which the PINE (i.e., PINE-1 107) is existing may be facing a hardware failure, or services may be scheduled to be offered for a certain time period/duration, or for any other reason which could be implementation specific or deployment specific.

At step 133, the PINE-1 107 transmits a PIN services de-registration request to the PEMC 103 when the PINE-1 107 decides to de-register the one or more new services. Analogously, the PEMC 103 receives the PIN services de-registration request from the PINE-1 107 of the PIN to de-register the one or more new services. The PIN services de-registration request comprises a PIN identifier, a PINE (i.e., PINE-1 107) identifier, and a second list of the one or more new services the PINE (i.e., PINE-1 107) is de-registering. The second list of the one or more new services comprises a unique service identifier, and a human readable description of a service.

At step 135, upon receiving the PIN services de-registration request from the PINE-1 107, the PEMC 103 validates or checks whether the PINE-1 107 is allowed to de-register the one or more new services. In detail, the PEMC 103 checks whether the PINE-1 107 is allowed to de-register the one or more new services by checking the PIN profile of the PIN. The PIN profile refers to configuration of the PIN and comprises information such as the type of services allowed, assignment of the role of PEMC, and PEGC, and the number of PINE allowed to be part of the PIN.

At step 137, upon validation, the PEMC 103 transmits a PIN services de-registration response to the PINE-1 107. Analogously, the PINE-1 107 receives the PIN services de-registration response from the PEMC 103. The PIN services de-registration response contains success or failure status of the PIN services de-registration request.

At step 139, upon successful validation at step 137, the PEMC 103 notifies details of the one or more new services of the PINE-1 107 de-registered to all PIN entities in the PIN. At this stage, all PIN entities update their PIN dynamic information to remove details of the one or more new services de-registered. The PIN entities comprises at least one of the PIN server 101, the PEGC 105, the PINE-1 107, the PINE-2 109, and PINE-3 111. In case, the validation was unsuccessful at step 137, the step 139 is not performed or is omitted.

The system and the method of the present disclosure for managing PIN services is applicable to, but not limited to, 5G and 6G wireless communication networks.

FIG. 1C illustrates an environment for managing a PIN for PIN services de-registration in accordance with some embodiments of the present disclosure.

With reference to FIG. 1C, the environment 100c comprises of the PIN server 101, the PEMC 103, the PEGC 105, and one or more PINEs i.e., the PINE-1 107, the PINE-2 109, and the PINE-3 111. The PIN server 101, the PEMC 103, the PEGC 105, and the one or more PINEs i.e., the PINE-1 107, the PINE-2 109, and the PINE-3 111 are all part of the same PIN. The PIN server 101, the PEMC 103, the PEGC 105, and the one or more PINEs i.e., the PINE-1 107, the PINE-2 109, and the PINE-3 111 may be referred as the PIN entities. In one embodiment, the PIN server 101, the PEMC 103, the PEGC 105, and the one or more PINEs i.e., the PINE-1 107, the PINE-2 109, and the PINE-3 111 form a system. In another embodiment, only the PEMC 103 is part of the system.

The operation for managing the PIN for PIN services de-registration is explained with reference to FIG. 1C where services are de-registered by the PEMC 103. This operation or procedure is applicable when the PEMC 103 is deciding to remove/suspend some or all of the services being offered by the PIN. In this case, the PEMC 103 may request the PINEs which are offering the service to stop offering the services. Once the PINE sends the successful response, the PEMC 103 notifies all the PIN entities including the PEMC 103 and the PEGC 105 about the details of the services being de-registered. The pre-conditions to perform this procedure or operation are (1) the PIN is already created or present and the PIN server 101, the PEMC 103, the PEGC 105, and the one or more PINEs i.e., the PINE-1 107, the PINE-2 109, and the PINE-3 111 are all part of the same PIN and (2) the PINE-4 is currently the primary PEMC 103 of the PIN. For the sake of brevity only the case of the PEMC 103 is de-registering the service(s) being offered by the PINE-1 107 is shown in FIG. 1C. As an example, the PINE-1 107 is currently offering one or more new services in the PIN. For the PIN services de-registration procedure, the term “one or more new services” may be referred as “one or more services,” since the PIN services de-registration procedure is applicable to the one or more new services added during the PIN services registration (as explained with reference to FIG. 1A) and/or to the one or more services that existed with the PINEs while joining the PIN.

Furthermore, the steps for performing this procedure are as follows.

PEMC (PINE-4), PEGC, PINE-1, PINE-2, PINE-3 all are joined as part of same PIN.

At step 141, the PEMC 103 decides to de-register some or all of new services that the PINE-1 107 currently offers. This may happen because the PIN owner or PIN admin may configure a time period or duration associated with the services being offered and when it is expired or any other reason which may be implementation specific or deployment specific.

At step 143, the PEMC 103 transmits a PIN services de-registration request to the PINE-1 107 to de-register some or all of the new services. The PIN services de-registration request comprises a PIN identifier, a PINE (i.e., PINE-1 107) identifier, and a second list of the one or more new services the PINE (i.e., PINE-1 107) is de-registering. The second list of the one or more new services comprises a unique service identifier, and a human readable description of a service.

At step 145, upon receiving the PIN services de-registration request from the PEMC 103, the PINE-1 107 stops offering the service.

At step 147, the PINE-1 107 transmits a PIN services de-registration response to the PEMC 103 in response to the PIN services de-registration request.

At step 149, upon receiving the PIN services de-registration response at step 147, the PEMC 103 notifies details of the one or more new services of the PINE-1 107 de-registered to all PIN entities in the PIN. At this stage, all PIN entities update their PIN dynamic information to remove details of the one or more new services de-registered. The PIN entities comprises at least one of the PIN server 101, the PEGC 105, the PINE-1 107, the PINE-2 109, and PINE-3 111.

The system and the method of the present disclosure for managing PIN services is applicable to, but not limited to, 5G and 6G wireless communication networks.

In one embodiment, the PIN server 101 may de-register the services being offered by the PIN. In this case, the PIN server 101 may send the PIN services de-registration to the PINEs which may offer the services being de-registered. Further, the request may be directly sent to the PINEs, or the PIN server 101 may send the request to the PEGC 105 or the PEMC 103, and the PEMC 103 or the PEGC 105 can route the request to the targeted PINEs.

In one embodiment, the PINEs may send a PIN join request or PIN register request again to the PEMC 103 or the PIN server 101 with the updated PINE profile or client profile. If the PINE is offering a new service, the PINE can update the PINE profile or client profile to carry the details of the new PIN service the PINE is offering and may further send the updated PINE profile in the PIN join or PIN register request. Similarly, if the PINE is de-registering any of the PIN services the PINE is offering currently, the PINE may update the PINE profile or client profile by deleting the details of the services and send the updated PINE profile or client profile. The PIN server 101 or the PEMC 103 on receiving the PIN register or PIN join request again from the PINE may compare the previous profile to identify the list of one or more new services being registered or de-registered and may further notify all the PIN entities accordingly.

The present disclosure discloses that as part of the PIN profile, optionally against each of the services being offered by the PIN, there may be the time duration or time period associated. This means that, if a particular service is scheduled to be available for particular hours say (9 am to 5 PM), the PEMC 103 or the PIN server 101 de-registers or deactivates the service once the time period expires by following the service de-registration procedure. Also, the PINE can also indicate the schedule associated with the service the PINE is offering as part of the PIN client profile which is shared by the PINE to the PEMC 103 and/or the PIN server 101 while registering or joining into the PIN.

In an embodiment, the PIN service parameter in the PIN profile (Clause ‘8.2.2.1 PIN Profile in a PIN’ of 3GPP TS 23.542 V0.2.0) may be extended to carry the time duration or time period information against each service being offered in the PIN. Further, the supported services parameter in the PIN client profile (Clause ‘8.2.2.3 PIN Profile in a PIN’ of 3GPP TS 23.542 V0.2.0) may be extended to carry the time duration or time period information against each service being offered by the PINE.

Once the service is de-registered, the PEMC 103 or PIN server 101 or PINEs may not allow other PINEs to access or utilize the de-registered services.

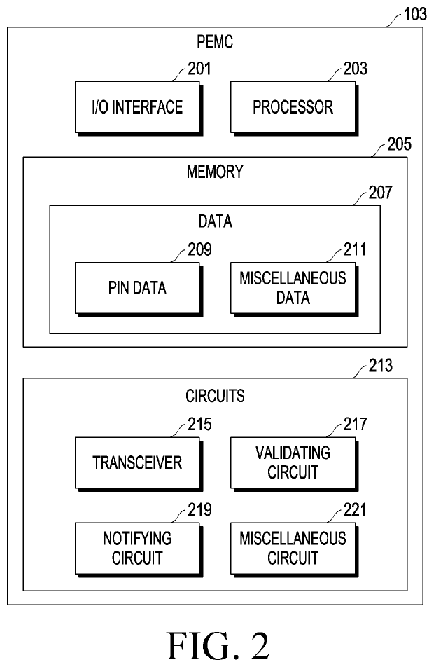

FIG. 2 illustrates a PEMC of a system for managing PIN services in accordance with some embodiments of the present disclosure.

The PEMC 103 is a part of the system. The PEMC 103 for managing PIN services includes an I-O interface 201, a processor 203, and a memory 205. In the present embodiment, data 207 is stored within the memory 205.

The I-O interface 201 is configured to receive a PIN services registration request and to transmit a PIN services registration response. The I-O interface 201 employs communication protocols or methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11B/g/n/x, Bluetooth, cellular e.g., Code-Division Multiple Access (CDMA), High-Speed Packet Access (HSPA+), Global System for Mobile communications (GSM®), Long-Term Evolution (LTER), Worldwide interoperability for Microwave access (WiMax®), or the like.

The memory 205 is communicatively coupled to the processor 203 of the PEMC 103. The memory 205, also, stores processor-executable instructions which cause the processor 203 to execute the instructions for managing PIN services. The memory 205 includes, without limitation, memory drives, removable disc drives, etc. The memory drives may further include a drum, magnetic disc drive, magneto-optical drive, optical drive, RAID, solid-state memory devices, solid-state drives, etc.

The processor 203 includes at least one data processor for managing PIN services. The processor 203 may include specialized processing circuits such as integrated system (bus) controllers, memory management control circuits, floating point circuits, graphics processing circuits, digital signal processing circuits, etc.

The data 207 include, for example, PIN data 209, and miscellaneous data 211.

PIN data 209: The PIN data 209 stores data related to PIN services registration request and PIN services de-registration request. The PIN services registration request comprises a PIN identifier, a PINE identifier, and a first list of the one or more new services the PINE is offering. The first list of the one or more new services comprises a unique service identifier, a human readable description of a service, and time duration of when the service is available. The PIN services de-registration request comprises the PIN identifier, the PINE identifier, and a second list of the one or more new services the PINE is de-registering. The second list of the one or more new services comprises the unique service identifier, and the human readable description of the service.

Miscellaneous data 211: the miscellaneous data 211 stores data, including meta data, and temporary files, generated by the circuits of the PEMC 103 for performing the various functions of the PEMC 103.

In the embodiment of the present disclosure, the data 207 in the memory 205 are processed by the one or more circuits 213 (also, referred as circuits) of the PEMC 103. In the embodiment, the one or more circuits 213 are implemented as dedicated hardware circuits (e.g., circuits). As used herein, the term unit refers to, for example, an ASIC, an electronic circuit, a PSoC, a combinational logic circuit, and/or other suitable components that provide the described functionality. In one embodiment of the present disclosure, the one or more circuits 213 are communicatively coupled to the processor 203 for managing PIN services. The one or more circuits 213 when configured with the functionality defined in the present disclosure results in a novel hardware.

In one implementation, the one or more circuits 213 include, but are not limited to, a transceiver 215, a validating unit 217, and a notifying unit 219. The one or more circuits 213, also, includes miscellaneous circuits 221 to perform various miscellaneous functionalities of the PEMC 103.

Transceiver 217: For registering one or more new services, the transceiver 217 of the PEMC 103 receives a PIN services registration request from a PINE (i.e., PINE-1 107) of the PIN. The PIN services registration request is sent by the PINE (i.e., PINE-1 107) when the PINE (i.e., PINE-1 107) decides to register the one or more new services that the PINE (i.e., PINE-1 107) can offer (or the PINE offers) (or the PINE is capable of offering) which the PINE (i.e., PINE-1 107) was not offering at a time of joining the PIN.

Upon validation by the validating circuit 217, the transceiver 217 of the PEMC 103 transmits a PIN services registration response to the PINE (i.e., PINE-1 107). The PIN services registration response contains success or failure status of the PIN services registration request.

For de-registering one or more new services, the transceiver 217 of the PEMC 103 receives a PIN services de-registration request from a PINE (i.e., PINE-1 107) of the PIN. The PIN services de-registration request is sent by the PINE (i.e., PINE-1 107) when the PINE (i.e., PINE-1 107) decides to de-register the one or more new services that the PINE (i.e., PINE-1 107) currently offers.

For de-registering one or more new services, the transceiver 217 of the PEMC 103 transmits a PIN services de-registration request to a PINE (i.e., the PINE-1 107) to de-register some or all of the new services. In response to the PIN services de-registration request, the transceiver 217 of the PEMC 103 receives a PIN services de-registration response from the PINE (i.e., PINE-1 107).

Upon validation by the validating circuit 217, the transceiver 217 of the PEMC 103 transmits a PIN services de-registration response to the PINE (i.e., PINE-1 107). The PIN services de-registration response contains success or failure status of the PIN services de-registration request.

Validating circuit 217: The validating circuit 217 of the PEMC 103 validates whether the one or more new services being offered by the PINE (i.e., PINE-1 107) can be part of the PIN (or are part of the PIN). In detail, the validating circuit 217 checks whether the one or more new services are allowed to be offered by the PIN by checking a PIN profile of the PIN. The PIN profile refers to configuration of the PIN and comprises information such as a type of services allowed, assignment of a role of PEMC, and PEGC, and a number of PINE allowed to be part of the PIN.

The validating circuit 217 of the PEMC 103 validates whether the PINE (i.e., PINE-1 107) is allowed to de-register the one or more new services. In detail, the validating circuit 217 checks whether the PINE (i.e., PINE-1 107) is allowed to de-register the one or more new services by checking a PIN profile of the PIN.

Notifying circuit 219: The notifying circuit 219 of the PEMC 103, upon successful validation by the validating circuit 217, notifies at least one of details of the one or more new services and the details of the PINE (i.e., PINE-1 107) offering the one or more new services to all PIN entities in the PIN. The PIN entities comprises at least one of a PIN server (i.e., PIN server 101), a PEGC (i.e., PEGC 105), and one or more other PINE (i.e., PINE-1 107, PINE-2 109, PINE-3 111).

The notifying circuit 219 of the PEMC 103, upon successful validation by the validating circuit 217, notifies details of the one or more new services of the PINE (i.e., PINE-1 107) de-registered to all PIN entities in the PIN. The PIN entities comprises at least one of a PIN server (i.e., PIN server 101), a PEGC (i.e., PEGC 105), and one or more other PINE (i.e., PINE-1 107, PINE-2 109, PINE-3 111).

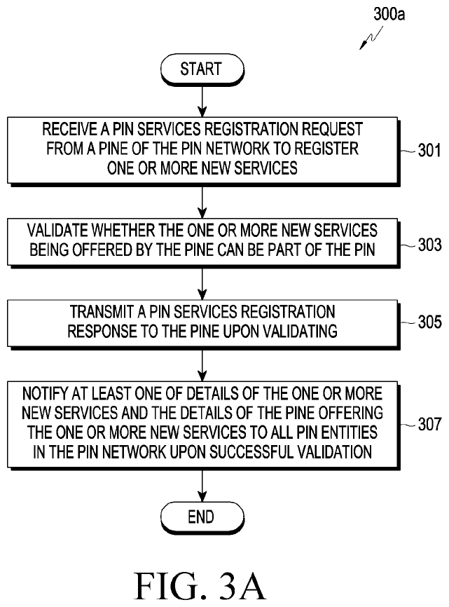

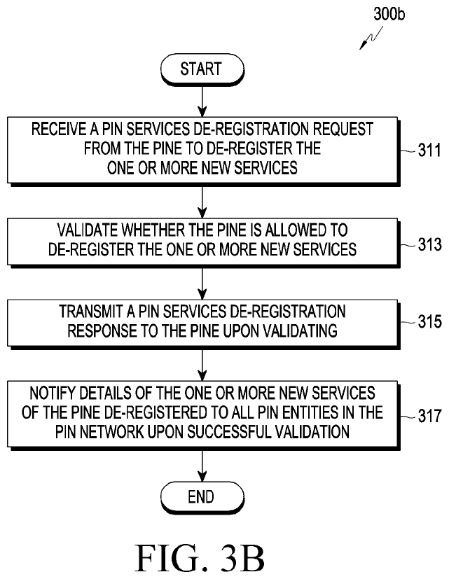

FIG. 3A illustrates a flowchart of a method for managing a PIN for PIN services registration in accordance with some embodiments of the present disclosure.

As illustrated in FIG. 3A, the method 300a includes one or more operation steps for managing a PIN for PIN services registration in accordance with some embodiments of the present disclosure. The method 300a may be described in the general context of computer executable instructions. Generally, computer executable instructions can include routines, programs, objects, components, data structures, procedures, modules, and functions, which perform particular functions or implement particular abstract data types.

The order in which the method 300a is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 301, the PEMC 103 of the PIN receives a PIN services registration request from a PINE (i.e., PINE-1 107) of the PIN to register one or more new services. The PIN services registration request is sent by the PINE (i.e., PINE-1 107) when the PINE (i.e., PINE-1 107) decides to register the one or more new services that the PINE (i.e., PINE-1 107) can offer (or the PINE offers) (or the PINE is capable of offering) which the PINE (i.e., PINE-1 107) was not offering at a time of joining the PIN. The PIN services registration request comprises a PIN identifier, a PINE identifier, and a first list of the one or more new services the PINE (i.e., PINE-1 107) is offering. The first list of the one or more new services comprises a unique service identifier, a human readable description of a service, and time duration of when the service is available.

At operation step 303, the PEMC 103 validates whether the one or more new services being offered by the PINE (i.e., PINE-1 107) can be part of the PIN (or are part of the PIN).

At operation step 305, the PEMC 103, upon validating, transmits a PIN services registration response to the PINE (i.e., PINE-1 107). The PIN services registration response contains success or failure status of the PIN services registration request.

At operation step 307, the PEMC 103, upon successful validation, notifies at least one of details of the one or more new services and the details of the PINE (i.e., PINE-1 107) offering the one or more new services to all PIN entities in the PIN. The PIN entities comprises at least one of a PIN server (i.e., PIN server 101), a PEGC (i.e., PEGC 105), and one or more other PINE (i.e., PINE-1 107, PINE-2 109, PINE-3 111).

FIG. 3B illustrate a flowchart of a method for managing a PIN for PIN services de-registration in accordance with some embodiments of the present disclosure.

As illustrated in FIG. 3B, the method 300b includes one or more operation steps for managing a PIN for PIN services de-registration in accordance with some embodiments of the present disclosure. The method 300b may be described in the general context of computer executable instructions. Generally, computer executable instructions can include routines, programs, objects, components, data structures, procedures, modules, and functions, which perform particular functions or implement particular abstract data types.

The order in which the method 300b is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 311, the PEMC 103 of the PIN receives a PIN services de-registration request from a PINE (i.e., PINE-1 107) of the PIN to de-register one or more new services. The PIN services de-registration request is sent by the PINE (i.e., PINE-1 107) when the PINE (i.e., PINE-1 107) decides to de-register the one or more new services that the PINE (i.e., PINE-1 107) currently offers. The PIN services de-registration request comprises a PIN identifier, a PINE identifier, and a second list of the one or more new services the PINE (i.e., PINE-1 107) is de-registering. The second list of the one or more new services comprises a unique service identifier, and a human readable description of a service.

At operation step 313, the PEMC 103 validates whether the PINE (i.e., PINE-1 107) is allowed to de-register the one or more new services.

At operation step 315, the PEMC 103, upon validating, transmits a PIN services de-registration response to the PINE (i.e., PINE-1 107). The PIN services de-registration response contains success or failure status of the PIN services de-registration request.

At operation step 317, the PEMC 103, upon successful validation, notifies details of the one or more new services of the PINE (i.e., PINE-1 107) de-registered to all PIN entities in the PIN. The PIN entities comprises at least one of a PIN server (i.e., PIN server 101), a PEGC (i.e., PEGC 105), and one or more other PINE (i.e., PINE-1 107, PINE-2 109, PINE-3 111).

Some of the advantages of the present disclosure are listed below.

PIN deployment becomes usable when the PIN is offering services and the services at any given point of time is accurate for better user experience. Without the method of the present disclosure, the services being offered by the PIN is not accurately advertised and thus, causing mismatch and/or poor user experience upon availing such service(s). For instance, if any PINE is upgraded with a new hardware which results in extra services the PINE offers then there is no way for the PINE to convey the extra services the PINE offers without leaving the PIN and rejoining again. Analogously, when any of the PINE is not offering the services, the PINE was offering at the time of joining the PIN due to any hardware or software failure, the PINE may leave and rejoin the PIN. This approach is not a viable and an efficient solution. The method described in the present disclosure overcomes the above-mentioned problems, thereby, providing a viable and an efficient solution for managing the PIN services.

In the present disclosure, PIN owner or PIN admin is able to associate the time period or duration with each of the services being offered by the PIN.

In the present disclosure, PIN owner or PIN admin can deregister or register a service into the PIN at any point of time via the PEMC or the PIN server or via the PINE.

In the present disclosure, if any PIN services becomes unavailable due to any hardware failure, it is notified to all the PIN entities and there is no mismatch in the services being offered by the PIN.

Some of the clauses are mentioned below.

[1]: A method for managing personal IoT network (PIN) services, the method comprising:
receiving, by a PIN element with management capability (PEMC) of the PIN, a PIN services registration request from a PIN element (PINE) of the PIN to register one or more new services;
validating, by the PEMC, whether the one or more new services being offered by the PINE can be part of the PIN; and
transmitting, by the PEMC, a PIN services registration response to the PINE upon validating.

[2]: The method described in [1], wherein validating whether the one or more new services being offered by the PINE can be part of the PIN comprises:
checking, by the PEMC, whether the one or more new services are allowed to be offered by the PIN by checking a PIN profile of the PIN.

[3]: The method described in [1], wherein the PIN services registration request is sent by the PINE when the PINE decides to register the one or more new services that the PINE can offer which the PINE was not offering at a time of joining the PIN.

[4]: The method described in [1], wherein the PIN services registration request comprises a PIN identifier, a PINE identifier, and a first list of the one or more new services the PINE is offering, and wherein the first list of the one or more new services comprises a unique service identifier, a human readable description of a service, and time duration of when the service is available.

[5]: The method described in [1], wherein the PIN services registration response contains success or failure status of the PIN services registration request.

[6]: The method described in [1], further comprises:
notifying, by the PEMC, at least one of details of the one or more new services and the details of the PINE offering the one or more new services to all PIN entities in the PIN upon successful validation,
wherein all PIN entities update their PIN dynamic information with the at least one of details of the one or more new services and the details of the PINE offering the one or more new services.

[7]: The method described in [1], the method comprising:
receiving, by the PEMC, a PIN services de-registration request from the PINE to de-register the one or more new services;
validating, by the PEMC, whether the PINE is allowed to de-register the one or more new services; and
transmitting, by the PEMC, a PIN services de-registration response to the PINE upon validating.

[8]: The method described in [7], wherein validating whether the PINE is allowed to de-register the one or more new services comprises:
checking, by the PEMC, whether the PINE is allowed to de-register the one or more new services by checking a PIN profile of the PIN.

[9]: The method described in [7], wherein the PIN services de-registration request is sent by the PINE when the PINE decides to de-register the one or more new services that the PINE currently offers.

[10]: The method described in [7], wherein the PIN services de-registration request comprises a PIN identifier, a PINE identifier, and a second list of the one or more new services the PINE is de-registering, and
wherein the second list of the one or more new services comprises a unique service identifier, and a human readable description of a service.

[11]: The method described in [7], wherein the PIN services de-registration response contains success or failure status of the PIN services de-registration request.

[12]: The method described in [7], further comprises:
notifying, by the PEMC, details of the one or more new services of the PINE de-registered to all PIN entities in the PIN upon successful validation,
wherein all PIN entities update their PIN dynamic information to remove details of the one or more new services de-registered.

[13]: The method described in [6] or [12], wherein the PIN entities comprises at least one of a PIN server, a PINE with gateway capability (PEGC) and one or more other PIN Elements.

[14]: A system for managing personal IoT network (PIN) services, the system comprising:
a PIN element with management capability (PEMC) comprising:
a processor; and
a memory communicatively coupled to the processor, wherein the memory
stores processor-executable instructions, which on execution, cause the processor to:
receive a PIN services registration request from a PIN Element (PINE) of the PIN to register one or more new services;
validate whether the one or more new services being offered by the PINE can be part of the PIN; and
transmit a PIN services registration response to the PINE upon validating.

[15]: The system described in [14], wherein the processor is configured to:
check whether the one or more new services are allowed to be offered by the PIN by checking a PIN profile of the PIN.

[16]: The system described in [14], wherein the PIN services registration request is sent by the PINE when the PINE decides to register the one or more new services that the PINE can offer which the PINE was not offering at a time of joining the PIN.

[17]: The system described in [14], wherein the PIN services registration request comprises a PIN identifier, a PINE identifier, and a first list of the one or more new services the PINE is offering, and
wherein the first list of the one or more new services comprises a unique service identifier, a human readable description of a service, and time duration of when the service is available.

[18]: The system described in [14], wherein the PIN services registration response contains success or failure status of the PIN services registration request.

[19] The system described in [14], wherein the processor is configured to:
notify at least one of details of the one or more new services and the details of
the PINE offering the one or more new services to all PIN entities in the PIN upon successful validation,
wherein all PIN entities update their PIN dynamic information with the at least one of details of the one or more new services and the details of the PINE offering the one or more new services.

[20]: The system described in [14], wherein the processor is configured to:
receive a PIN services de-registration request from the PINE to de-register the one or more new services;
validate whether the PINE is allowed to de-register the one or more new services; and
transmit a PIN services de-registration response to the PINE upon validating.

[21]: The system described in [20], wherein the processor is configured to:
check whether the PINE is allowed to de-register the one or more new services
by checking a PIN profile of the PIN.

[22]: The system described in [20], wherein the PIN services de-registration request is sent by the PINE when the PINE decides to de-register the one or more new services that the PINE currently offers.

[23]: The system described in [20], wherein the PIN services de-registration request comprises a PIN identifier, a PINE identifier, and a second list of the one or more new services the PINE is de-registering, and
wherein the second list of the one or more new services comprises a unique service identifier, and a human readable description of a service.

[24]: The system described in [20], wherein the PIN services de-registration response contains success or failure status of the PIN services de-registration request.

[25]: The system described in [20], wherein the processor is configured to:
notify details of the one or more new services of the PINE de-registered to all PIN entities in the PIN upon successful validation,
wherein all PIN entities update their PIN dynamic information to remove details of the one or more new services de-registered.

[26]: The system described in or [25], wherein the PIN entities comprises at least one of a PIN server, a PINE with gateway capability (PEGC) and one or more other PIN Elements.

With respect to the use of substantially any plural and singular terms herein, those having skill in the art can translate from the plural to the singular and from the singular to the plural as is appropriate to the context or application. The various singular or plural permutations may be expressly set forth herein for sake of clarity.

One or more computer-readable storage media may be utilized in implementing embodiments consistent with the present disclosure. A computer-readable storage medium refers to any type of physical memory on which a software (program) readable by an information processing apparatus may be stored. The information processing apparatus includes a processor and a memory, and the processor executes a process of the software. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

The described operations may be implemented as a method, a system, or an article of manufacture using at least one of standard programming and engineering techniques to produce software, firmware, hardware, or any combination thereof. The described operations may be implemented as code maintained in a “non-transitory computer readable medium,” where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD ROMs, DVDs, optical disks, etc.), volatile and non-volatile memory devices (e.g., EEPROMs, ROMs, PROMs, RAMS, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, PGA, ASIC, etc.).

The terms “an embodiment,” “embodiment,” “embodiments,” “the embodiment,” “the embodiments,” “one or more embodiments,” “some embodiments,” and “one embodiment” mean “one or more (but not all) embodiments of the disclosure(s)” unless expressly specified otherwise.

The terms “including,” “comprising,” “having” and variations thereof mean “including but not limited to,” unless expressly specified otherwise.

The enumerated listing of items does not imply that any or all of the items are mutually exclusive, unless expressly specified otherwise.

The terms “a,” “an” and “the” mean “one or more,” unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device, or article, or a different number of devices or articles may be used instead of the shown number of devices or programs. At least one of the functionalities and the features of a device may be alternatively embodied by one or more other devices which are not explicitly described as having such functionality or features. Thus, other embodiments of the disclosure need not include the device itself.

The illustrated operations of FIGS. 3A, and 3B show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing circuit or by distributed processing circuits.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for managing a personal IoT network (PIN) services, the method comprising:
receiving, by a PIN element with management capability (PEMC) of the PIN, a PIN services registration request from a PIN element (PINE) of the PIN to register one or more new services;
validating, by the PEMC, whether the one or more new services being offered by the PINE can be part of the PIN; and
transmitting, by the PEMC, a PIN services registration response in response to the PIN services registration request to the PINE.

2. The method of claim 1, wherein validating whether the one or more new services being offered by the PINE can be part of the PIN comprises:
checking whether the one or more new services are allowed to be offered by the PIN by checking a PIN profile of the PIN.

3. The method of claim 1, wherein the PIN services registration request is transmitted by the PINE in case that the PINE decides to register the one or more new services that the PINE can offer which the PINE was not offering at a time of joining the PIN.

4. The method of claim 1, wherein the PIN services registration request comprises a PIN identifier, a PINE identifier, and a list of the one or more new services that the PINE is offering, and
wherein the list of the one or more new services comprises a unique service identifier, a human readable description of a service, and a time duration of when the service is available.

5. The method of claim 1, wherein the PIN services registration response includes a success status or a failure status of the PIN services registration request.

6. The method of claim 1, further comprising:
notifying at least one of information of the one or more new services or information of the PINE offering the one or more new services to entire PIN entities in the PIN,
wherein the entire PIN entities update PIN dynamic information with the at least one of the information of the one or more new services and the information of the PINE offering the one or more new services.

7. The method of claim 6, wherein the entire PIN entities include at least one of a PIN server, a PINE with gateway capability (PEGC), or one or more other PIN elements.

8. A method for managing a personal IoT network (PIN) services, the method comprising:
receiving, by a PIN element with management capability (PEMC) of the PIN, a PIN services de-registration request from a PIN element (PINE) to de-register one or more new services;
validating, by the PEMC, whether the PINE is allowed to de-register the one or more new services; and
transmitting, by the PEMC, a PIN services de-registration response in response to the PIN services de-registration request to the PINE.

9. The method of claim 8, wherein validating whether the PINE is allowed to de-register the one or more new services comprises:
checking whether the PINE is allowed to de-register the one or more new services by checking a PIN profile of the PIN.

10. The method of claim 8, wherein the PIN services de-registration request is transmitted by the PINE in case that the PINE decides to de-register the one or more new services that the PINE currently offers.

11. The method of claim 8, wherein the PIN services de-registration request includes a PIN identifier, a PINE identifier, and a list of the one or more new services that the PINE is de-registering, and
wherein the list of the one or more new services comprises a service identifier and a human readable description of a service.

12. The method of claim 8, wherein the PIN services de-registration response includes a success status or a failure status of the PIN services de-registration request.

13. The method of claim 8, further comprising:
notifying, by the PEMC, information of the one or more new services of the PINE de-registered to entire PIN entities in the PIN,
wherein the entire PIN entities update PIN dynamic information to remove the information of the one or more new services de-registered.

14. The method of claim 13, wherein the entire PIN entities comprise at least one of a PIN server, a PINE with gateway capability (PEGC), or one or more other PIN elements.

15. A personal IoT network element with management capability (PEMC) for managing a personal IoT network (PIN) services, the PEMC comprising:
memory; and
a processor communicatively coupled to the memory, and configured to:
receive a PIN services registration request from a PIN element (PINE) of the PIN to register one or more new services;
validate whether the one or more new services being offered by the PINE can be part of the PIN; and
transmit a PIN services registration response in response to the PIN services registration request to the PINE.

16. The PEMC of claim 15, wherein the processor is configured to:
check whether the one or more new services are allowed to be offered by the PIN by checking a PIN profile of the PIN.

17. The PEMC of claim 15, wherein the PIN services registration request is transmitted by the PINE in case that the PINE decides to register the one or more new services that the PINE can offer which the PINE was not offering at a time of joining the PIN.

18. The PEMC of claim 15, wherein the PIN services registration request comprises a PIN identifier, a PINE identifier, and a list of the one or more new services that the PINE is offering, and
wherein the list of the one or more new services comprises a unique service identifier, a human readable description of a service, and a time duration of when the service is available.

19. The PEMC of claim 15, wherein the PIN services registration response includes a success status or a failure status of the PIN services registration request.

20. The PEMC of claim 15, wherein the processor is further configured to:
notify at least one of information of the one or more new services or information of the PINE offering the one or more new services to entire PIN entities in the PIN,
wherein the entire PIN entities update PIN dynamic information with the at least one of the information of the one or more new services and the information of the PINE offering the one or more new services.
